(19) United States
(12) Patent Application Publication
(10) Pub. No.: US 2012/0041769 A1
(43) Pub. Date: Feb. 16, 2012

(54) REQUESTS FOR PROPOSALS MANAGEMENT SYSTEMS AND METHODS

(75) Inventors: Siddhartha Dalal, Santa Monica, CA (US); Daniella Meeker, Los Angeles, CA (US)

(73) Assignee: The Rand Corporation

(21) Appl. No.: 13/209,330

(22) Filed: Aug. 12, 2011

Related U.S. Application Data
(60) Provisional application No. 61/373,781, filed on Aug. 13, 2010.

(51) Int. Cl. G06Q 99/00

(52) U.S. Cl. 705/1.1

(57) ABSTRACT

An RFP management system improves the process of matching researchers with relevant research projects as described in RFPs. The system creates a researcher profile based on a scan of the researcher's reports and past proposals, scans web-based and other databases for project opportunities that fit the profile, and produces a subset of RFPs for the researcher or an agent to consider. The system includes search and matching features that enable identification of expertise among researchers based on the profile content to facilitate collaboration, and to suggest research teams with the best-matched expertise for each RFP. User interfaces allow researchers to refine their profiles and give feedback to allow the system to learn and improve performance. The system also can be adapted for any application where objects with common features are to be matched and presented or visualized.

### CROSS-REFERENCE TO RELATED PATENT APPLICATIONS

Embodiments of the present invention relate to U.S. Provisional Patent Application 61/373,781 filed on Aug. 13, 2010, and entitled “REQUESTS FOR PROPOSALS MANAGEMENT SYSTEMS AND METHODS,” which is incorporated herein in its entirety and forms a basis for a claim of priority.

### BACKGROUND

1. Field

Embodiments of the present invention generally relate to automated document collection and classification systems and methods. Specific embodiments generally relate to systems and methods for automated document collection and classification to match researcher expertise with research funding opportunities and to match suitable collaborators for research projects.

2. Related Art

Researchers in a variety of organizations—academic, commercial, non-commercial, in the United States and worldwide—rely on Requests for Proposal (RFPs) to learn about research opportunities in outside organizations and sometimes even within their own organizations. Indeed, many research institutions derive most of their funding from projects they win by responding to RFPs. However, to respond to the RFPs, researchers must be aware of them and have a way to determine whether the potential funding opportunities match their interests and expertise. Researchers also need to know whether another individual or institution is conducting research on which he or she might collaborate. Maintaining this awareness is no small task considering that on any given day thousands of RFPs are active from the United States federal government alone and thousands more are issued by other governments, universities, foundations, and other funding sources.

Current practice in the institutions is that researchers or support staffs are seated at a computer terminal and direct internet browsers to websites that host a limited set of online databases, or they sit at their computer terminals and read feeds from such databases in e-mail. The reader selects a set of RFPs using filters such as the presence of certain keywords, the deadline for submitting a proposal or for completing the project, and the amount of funding. Once the search produces a set of RFPs, the reader uses human judgment to review manually the text and he/she selects for further consideration those that are most relevant for the individual or institution. Following this process, the researcher may then go through another step of identifying collaborators based on their interests and experiences. Over time, the researcher or staff may revise this search strategy to improve the selection of terms and retrieve better matches for consideration.

The process is not just time consuming; it may also result in missed opportunities for the institution, for individual researchers within the institution, and even for the organization that issued the RFP. The database scan may omit key words that are unexpectedly relevant. Alternatively, perhaps the relevant key word—one of interest to a researcher—was buried within the text and therefore not picked up by a high-level scan. Alternatively, once the set of RFPs is selected for manual review, the researcher or staff person may run out of time before he/she gets to an RFP of interest at the bottom of the stack.

Table A lists various acronyms and definitions of terms as discussed in the disclosure.

TABLE A

| | |
|---|---|
| Agency | An agency releasing requests for proposals for funding |
| | opportunities |
| Browser | Computer software program that reads files in common formats |
| | from local and network sources; e.g., Internet Explorer, Mozilla |
| | Firefox |
| Cosine similarity | An algorithm used to calculate the cosine distance between two |
| | vectors; in this case vectors represent text documents |
| Custom exclusions | Filters that are manually set in order to exclude from search |
| | results content of interest |
| Data object | An instance of information with characteristics represented in a |
| | defined format and compared to other instances of the same type |
| Document | A text (or collection of text) presumed to be related to a |
| | particular topic or set of topics. In this context, a document may |
| | refer to RFP text, a text query, or text that represents a |
| | researcher profile |
| Dynamic data | Automated collection of data from sources triggered by events |
| collection | |
| Extract, transform, | Computer programs that extract data from a source, transform |
| load (ETL) | the data into a format compatible with end use, and load the data |
| programs | into the end use system |
| Graphical user | The means by which a user visualizes and interacts with a |
| interface (GUI) | system. The GUI may be a program that runs on a server and |
| | delivers information via an internet browser program; or the |
| | GUI may be an e-mail client that opens personalized email |
| | messages |
| Hypertext | Programming language used to generate HTML and other |
| preprocessor | browser-readable content |
| (PHP) | |
| Hypertext markup | Most common browser-readable format |
| language (HTML) | |
| Latent Semantic | Algorithms used to transform information represented in matrix |
| Indexing (LSI), | format into lower-dimensional sub-spaces |
| Matrix | |
| factorization, | |
| Multirelational | |
| matrix | |
| factorization (MRMF) | |
| Porter stemming | Algorithm used to map gerunds and plurals into root terms |
| Profile | A collection of documents, key words, and past proposals that |
| | embodies a potential user's interests relevant to collaboration or |
| | funding opportunities. Contents may be populated both |
| | automatically and manually by users. |
| Python | Scripted programming language that can run on multiple |
| | operating systems |
| R | Statistical programming language that can run on multiple |
| | operating systems |
| Requests for | Published text of a request for proposals, information, or |
| Proposals (RFPs) | applications. Entities we refer to as “RFPs” can be used |
| | interchangeably with any project description |
| Researcher | Any entity that has a profile on the system. A single user may |
| | have multiple profiles based on his/her differing interests, and a |
| | group of users may additionally have a single profile |
| | representing the group's interests |
| Similarity | Generic calculations that output a number representing the |
| calculations | similarity between two data objects, in this case between two |
| | vectors that represent “documents” as defined above |
| Similarity metric | The output of similarity calculations |
| Singular value | Linear-algebraic method of reducing the dimensionality of a |
| decomposition | space |
| (SVD) | |
| Stoplist | List of words excluded from analysis, frequently common |
| | words such as “the,” “of,” “this” |
| Term | Word, phrase, or token that may be present in content associated |
| | with researchers or projects and RFPs |
| Term-Document | A matrix indexing the weighted counts of each term (rows) in a |
| Matrix (TDM) | collection of documents (columns) |
| Token | Pre-defined phrases that are treated in the TDM in the same way |
| | as single words |
| Use case | “A use case is a methodology used in system analysis to |
| | identify, clarify, and organize system requirements. The use |
| | case is made up of a set of possible sequences of interactions |
| | between systems and users in a particular environment and |
| | related to a particular goal. It consists of a group of elements |
| | (e.g., classes and interfaces) that can be used together in a way |
| | that will have an effect larger than the sum of the separate |
| | elements combined. The use case should contain all system |
| | activities that have significance to the users.”¹ |

¹http://searchsoftwarequality.techtarget.com/sDefinition/0,,sid92_gci334062,00.html.

### SUMMARY OF THE DISCLOSURE

Various embodiments replicate the current human process in software to reduce the limitations of human error and time in order to efficiently deliver relevant RFPs to researchers based on automated collection of RFP documents and matching these RFPs to text-based researcher profiles using a matching process applying algorithms that emulate human judgment of semantic relevance. Various embodiments improve on the current process by more efficiently and thoroughly collecting and evaluating RFPs and detecting relevance to potential applicants' interests than might be done in the current human process. In various embodiments, based on feedback, the software may improve algorithms emulating the more personalized judgments over time. In various embodiments, the software identifies potential collaborators for an RFP application by detecting other researchers whose experience is relevant to the RFP. Thus, various embodiments provide for a system and method that executes this process in orders of magnitude more efficiently than the current practice.

Various embodiments are applicable to with commercial and non-commercial enterprises seeking national or international RFPs, tenders and even internal opportunities within the enterprise. In that case, researchers represent entities seeking the opportunities and collaborations and RFPs represent the opportunity.

Various embodiments are directed to a system (and/or a method implemented therein) that replicates the process that is currently performed by humans. The system uses automated document collection, ordering, and classification to match researcher expertise with active grants and RFPs. This provides an opportunity to substantially reduce costs and improve results by applying information analytics to data that are currently available on the web and within organizational databases. Accordingly, various embodiments relate to a computer system that is designed to improve the process of matching researchers with relevant research projects and opportunities for collaboration as described in researcher profiles and the thousands of RFPs issued each year by governments, universities, foundations, and other funding sources.

The system automatically collects RFPs and other documents describing project opportunities and matches them to text-based researcher profiles using algorithms that emulate human judgments of semantic relevance. Based on feedback collected via the user interface, the software may improve algorithms emulating the more personalized judgments over time. Finally, the software identifies potential collaborators for an RFP application by detecting other researchers whose experience is relevant to the RFP. Thus, in various embodiments, the system executes the process orders of magnitude more efficiently than the current process.

A semi-automated search-and-retrieve strategy that presents a researcher with a list of documents sorted by similarity to his interests has the potential to streamline the process and make it more effective and efficient. The system identifies RFPs most relevant to a researcher's interests, using semantic analysis methods to create an ordering of RFPs customized to each researcher's keywords. Various embodiments provide advantages over keyword search by accounting for synonymy and polysemi. Finally, the system includes an online interface designed so that researchers not only can browse opportunities that have been matched to their interests, but also navigate a network view of potential co-applicants and collaborators. Thus, a useful byproduct of various embodiments is that it enables researchers to identify collaborators for proposals that may be mutually interesting.

To use the system, documents are collected automatically and/or edited manually by researchers to create a personal profile of the researcher's interests and areas of expertise. The system picks up key words from reports, and text from past proposals the researcher has authored, for example. The system works in real time and scans several web-based and other databases to find funding opportunities that match the researcher's profile and then, using advanced statistical learning methods, creates a ranked list of opportunities and potential collaborators. Interactive user interfaces allow researchers to refine their profiles and searches to improve the performance of the system; i.e., produce project opportunities more relevant to their interests.

### BRIEF DESCRIPTION OF THE DRAWINGS

FIG. 1 is a general overview of an RFP management system according to an embodiment of the disclosure.

FIG. 2 is a view of a graphical user interface (GUI) displaying a login screen according to an embodiment of the disclosure.

FIG. 3 is a view of a GUI displaying a researcher centered-researcher-grant network diagram according to an embodiment of the disclosure.

FIG. 4 is a view of a GUI displaying a grant-centered researcher-grant network diagram according to an embodiment of the disclosure.

FIG. 5 is a view of a GUI displaying a researcher-researcher network diagram according to an embodiment of the disclosure.

FIG. 6 is a view of a GUI displaying a grant/RFP rating screen according to an embodiment of the disclosure.

FIG. 7 is a view of a GUI displaying a funding agency filtering screen according to an embodiment of the disclosure.

FIG. 8 is view of a GUI displaying a keyword/profile management interface according to an embodiment of the disclosure.

FIG. 9A is a chart of a receiving operating characteristic curve (ROC) for RFPs retrieved using a method according to an embodiment of the disclosure.

FIG. 9B is a curve using a method according to an embodiment of the disclosure.

### DETAILED DESCRIPTION

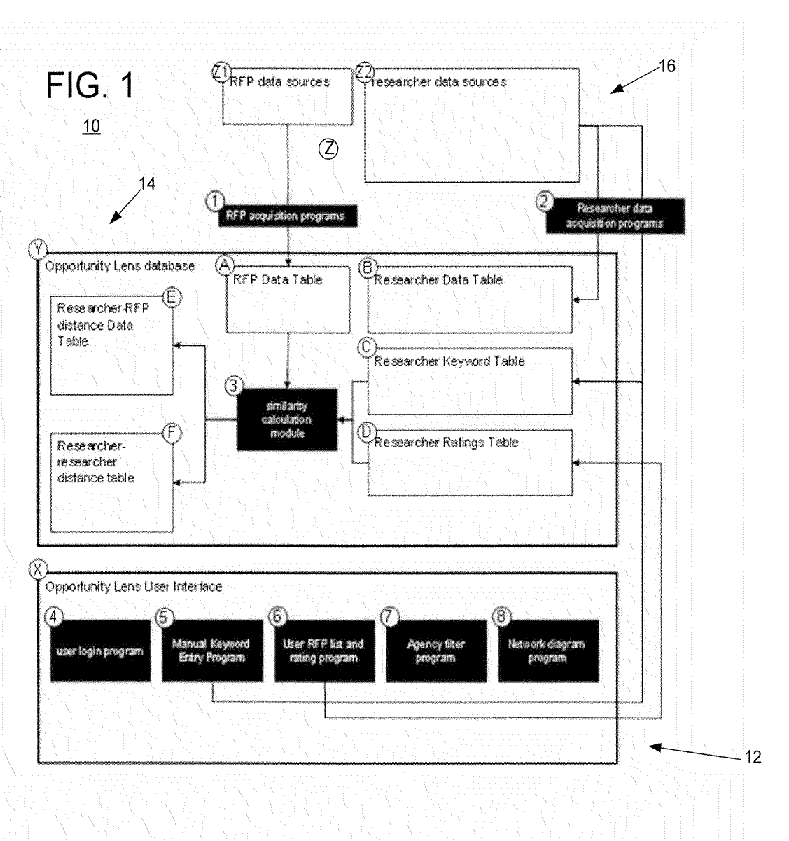

FIG. 1 is a general overview of an RFP management system 10 according to an embodiment of the disclosure. The black boxes in FIG. 1 represent parts of the system 10. The white boxes describe the data that become part of the system 10. The system 10 includes data sources Z, a database Y, and a user interface X. The arrows in FIG. 1 illustrate information flow between key operations of the system 10.

The data sources Z include data sources, such as (but not limited to) RFP data sources Z1 and research data sources Z2. RFP data sources Z1 include websites of funding agencies, internal project descriptions, and other digital text sources signifying opportunities. These include databases such as the grants.gov archive and websites such as fedbizops.gov. This might also include descriptions of other project opportunities that are not RFPs. Researcher data sources Z2 can come from organizational databases that maintain text about interests, past proposals, publications, and other data manually entered by researchers via a GUI.

The data sources Z are associated with RFP acquisition programs 1. The RFP data acquisition programs 1 are custom-coded programs written in Python and executed on a networked Linux operating system. They are “extract transform load” (ETL) programs that pull data from network sources that publish RFP data. The data can be transformed into the application's database schema. The programs and web sites from which an exemplary embodiment of the system 10 obtains active RFPs are listed in the Appendix.

The data sources Z are associated with researcher data acquisition programs 2. The researcher data acquisition programs 2 are written to seed researchers' profiles with information about their interests through direct queries to various databases. These databases include library lists of publications, from which keywords are abstracted, the employee directory database that holds researchers' contact information, past proposals, and Curricula Vitae. The researcher can also enter into the system his or her own list of interest areas or upload documents. Similar acquisition programs can be used to collect data from publications indexed in federated 2 databases such as the ISI Web of Knowledge, an academic citation indexing and search service that is combined with web linking and provided by Thomson Reuters. The database Y may be located on a local server or computer, for example, mySQL. The system's 10 native data system stores the data extracted via the data acquisition programs (e.g., 1, 2). These include the text data inputs to calculations—programmatically acquired data and user input. Similarity calculations based on advanced statistical methods produce outputs stored in two different distance tables that represent the similarities between researchers and RFPs.

The database Y may include, but is not limited to RFP data table A, researcher data table B, researcher keyword table C, researcher ratings table D, researcher-RFP distance data table E, and researcher-researcher distance table F.

Researchers may use meta-data about grants stored in the RFP data table A to filter results. For instance, filtering may be applied based on the funding agency, date, and/or the like. Here, for example, prospective applicants can customize the result list by selecting various funding agencies. The researcher data table B contains basic information about researchers, such as login information, organizational status, preferences about funding sources, and/or the like.

The researcher keyword table C contains text acquired in the researcher data acquisition programs 2 from the researcher data sources Z2.

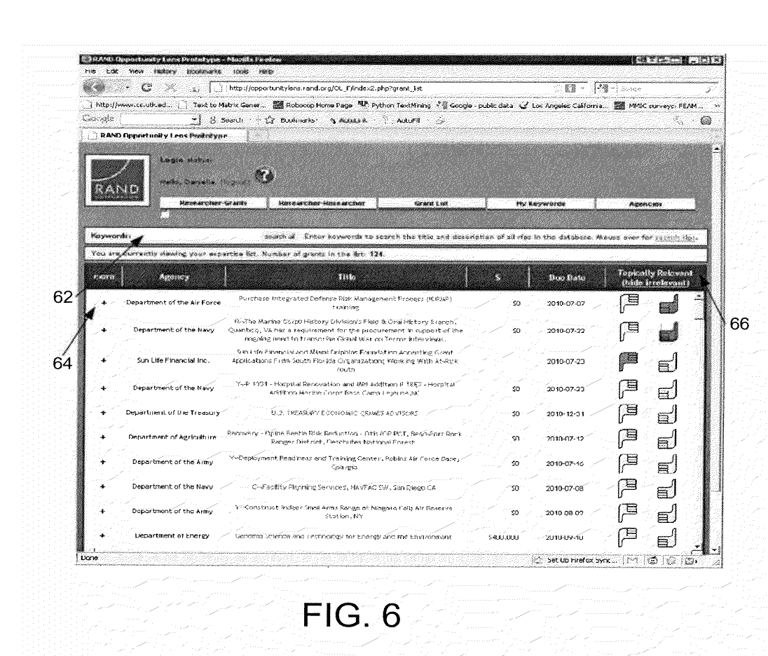

The researcher ratings table D stores information about how researchers implicitly (e.g., by monitoring mouse clicks) or explicitly (e.g., through direct entry of ratings as in FIG. 6) express their interest in RFPs that are presented to them. The researcher-RFP distance data table E provides a tabular view of the RFPs ordered by distance (relevance) to the user, based upon their expertise. Other data about the RFPs in the database may also be displayed, for example the funding level and due date. The researcher-researcher distance table F includes another set of similarity measures that indicate the similarities between the keywords lists of researchers that are stored in the researcher-researcher distance table F.

The database Y may also include (or be associated with) a similarity/learning calculation module 3. The similarity/learning calculation module 3 performs calculations based on statistical and machine learning methods that transform text and ratings data into similarity metrics and/or predictions of researcher interest in new RFPs. Several methods for these calculations are stored as programs in the system 10 with results and calculations triggered by different events.

In some embodiments, there are generally three steps that are required to generate the similarity/learning calculation module 3. First, the similarity model is defined (i.e., how the features of the available data are to be represented and transformed in a way that can generate valid similarity metrics). Next, a method for updating and estimating model parameters (if any) is defined. Then, the similarity metrics that will be calculated from model is defined. It should be noted that for many models, similarities can easily be calculated between content that was not part of the parameter estimation process. This process of incorporating new content for similarity calculation is often referred to as “folding-in” in the semantic analysis literature.

The user interface X, which, for example, may be at a remote terminal or local terminal connected to the server or computer having the database Y is configured to gather RFP text from online sources and use semantic analysis to rank RFPs by relevance to each researcher's expertise.

The user interface X provides various views into the data system and enables users to rate the RFPs. The user interface X includes a basic login program 4 that retrieves stored information setting session parameters to the researcher's personalized values. A manual keyword entry program 5 allows researchers to modify their stored profiles by changing the words associated with their interests. User RFP list and rating program 6 presents a list of RFPs ordered by calculated similarity to the logged-in researcher's interests with links to full content and a rating buttons that enable researchers to rate the relevance of each RFP in the result list. Agency filter program 7 restricts the results presented to a researcher by eliminating results from selected funding sources selected by a particular user.

Similarity measures between researchers and RFP and similarity measures between each pair of researchers' keywords are stored in the researcher-RFP distance table E and the researcher-researcher distance table F. Network diagram program 8 renders these distances in interactive network diagram visualizations, for example, with nodes represented as circles connected by edges proportional to distances between the nodes representing researchers or RFPs. The network diagram program 8 may include various parameters such as the number of degrees of network separation to show, what type of information is shown in each such degree, and/or the like. In particular embodiments, the network diagram program 8 relays the calculations to an open source diagram layout program, such as AiSee, to complete the rendering and layout.

Table 1 provides more information about these processes, whether they are executed by human intervention or machine-triggered programs, and how they correspond to FIG. 1. In particular, Table 1 describes how each of the boxed elements is generated and how each of the box elements correspond to the user interface (if applicable).

TABLE 1
Components of Process.

| | | | | | Message/Event | | |
|---|---|---|---|---|---|---|---|
| | | | | | that triggers | | |
| | | | | | operation in | Platforms/ | |
| | | | | Manual and/or | Opportunity Lens | Formats in use | Reference |
| Operation | Frequency | Inputs | Outputs | Machine | use case | case | in FIGURE |
| Modeling input | Once per | Source | Programs | Manual | Request/recognized | Programs created: | (Z1), (Z2) to |
| sources | input | schema | that | customization | need for additional | Python; PHP | (1) |
| | source | | transform | of programs for | data source | | |
| | | | data from | a new source | | | |
| | | | source | | | | |
| | | | format to | | | | |
| | | | system | | | | |
| | | | format | | | | |
| Extract, | Continuous | Data | Data in | Machine | Scheduled task on | Operating system: | (1) to (A) |
| transfer, load | | objects in | system | | Linux operating | Linux | |
| data from | | source | format | | system | Destination | |
| sources into | | format | | | | Database: MySQL | |
| system database | | (e.g., XML, | | | | Source formats: | |
| | | HTML, | | | | xml, HTML, Oracle | |
| | | Oracle) | | | | | |
| Define analytic | Once per | Knowledge | Programs | Manual; | Initial requirement | Programs created: | Domain |
| transformations: | analytic | of analytic | executing | machine | that can be updated | MATLAB, PHP, R | knowledge |
| (1) Define | method | problem | analytic | adaptive | as needed. | Analytic model: | to (3) |
| similarity model | | | methods | algorithms | | Dimension | |
| (2) Define | | | using | | | reduction by matrix | |
| method for | | | system data | | | factorization of | |
| updating and | | | format | | | various types (e.g., | |
| estimating model | | | | | | Latent Semantic | |
| parameters, if | | | | | | Indexing). | |
| any. | | | | | | Similarity by cosine | |
| (3) Define | | | | | | distance calculation | |
| method for | | | | | | weighted by user | |
| calculating | | | | | | ratings. Combining | |
| similarity | | | | | | of output of | |
| metrics from | | | | | | different | |
| model | | | | | | dimensions. | |
| | | | | | | Updating by nearest | |
| | | | | | | neighbor method | |
| | | | | | | and statistical | |
| | | | | | | learning method | |
| Run similarity | Continuous | Data in | Similarity | Machine | Changes made via | Operating system: | (A), (B), (C), |
| calculations | | system | between | | user interface; | Linux | (D) to |
| | | format | analytic | | Scheduled task on | | (E), (F) |
| | | | objects | | Linux operating | | |
| | | | | | system | | |
| Create user | Once per | Data in | Interface | Manual | Identified need and | Programs created: | (4), (5), (6), |
| interface | interface | system | that | | requirements for | PHP, perl, aiSee, | (7), (8), (X) |
| programs | | format, user | conveys | | interface | HTML, javascript | |
| | | inputs, | similarity | | | | |
| | | similarity | data to and | | | | |
| | | between | collects | | | | |
| | | analytic | information | | | | |
| | | objects | from users | | | | |
| Collect | Continuous | User | Data in | Machine | User ratings of | Interface to GUI: | (5) to (C), (6) |
| interactive data | | entered | system | records user | RFPs | Mozilla Firefox | to (D) |
| via user | | data | format | interactions | User entered | Browser | |
| interface | | | | | keywords | Destination | |
| | | | | | | database: MySQL | |

In various embodiments, operation of defining analytic methods for similarity calculations generally has three steps (1) defining the general model for similarity calculation; (2) identifying the mechanism for setting the parameters of such a model; and (3) defining the mechanism by which similarity between two instances of data objects can be calculated using the defined model. Creating the programs for these operations enables automatically triggered calculations of distance functions and updating of model parameters based on newly available data and feedback. The similarity metric itself may take a categorical form (such as “recommended,” “not recommended,” and/or the like) or a continuous form (a distance defined on the real scale). Programs for running similarity calculations execute the defined methods—these programs automatically update model parameters in addition to executing the similarity calculations. Each of these abstract operations is embodied in the use case described, triggered by scheduled events on the underlying operating system and/or activity in the user interface X. Updates to the stored data and filtering selections trigger recalculation of similarities, and reordering of the data in the other screens of the interface.

The user interface X may be accessible by a user at a terminal device 12 (e.g., computer, cell phone, tablet, PDA, etc.). The user interface X provides, for example over a network (e.g., wide area network (e.g., Internet), local area network, or the like), the user at the terminal device 12 access to server 14 on which the database Y is located. Thus, in some embodiments, the terminal device 12 is remote from the server 14 (and/or the one or more servers 16). The server 14 may be coupled to one or more servers 16 or the like on which the data sources Z1, Z2 are located to allow the server 14 to communicate with the one or more servers 16, for example over a network (e.g., a wide area network, a local area network, or the like).

As shown in FIG. 1, the researcher data sources Z2 is accessed by the researcher data acquisition programs 2, which interacts at least with (but not limited to) with the researcher data table B, the researcher keyword table C, the researcher ratings table D. In addition, data of at least (but not limited to) the researcher data table B, the researcher keyword table C, the researcher ratings table D may be based on data from the manual keyword entry program 5. In some embodiments, the researcher data acquisition programs 2 are located on a same server (e.g., 14) as the database Y. In other embodiments, the researcher data acquisition programs 2 are located on a same server (e.g., 16) as the researcher data sources Z2. In yet other embodiments, the researcher data acquisition programs 2 are located on a different server from the researcher data sources Z2 and the database Y.

The RFP data sources Z1 are accessed by the RFP acquisition programs 1. The RFP acquisition programs 1 may interact with the RFP data table A. In some embodiments, the RFP acquisition programs 1 are located on a same server (e.g., 14) as the database Y. In other embodiments, the RFP acquisitions programs 1 are located on a same server (e.g., 16) as the RFP data sources Z1. In yet other embodiments, the RFP acquisition programs 1 are located on a different server from the RFP data sources Z1 and the database Y.

The similarity calculation module 6 may be based on data from at least (but not limited to) the RFP data table A, the researcher data table B, the research keyword table C, and the researcher ratings table D. The researcher ratings table D may be based on at least (but not limited to) the user RFP list and rating program 6. The similarity calculation module 3 may provide data to at least (but not limited to) the researcher-RFP distance data table E and the researcher-researcher distance table F.

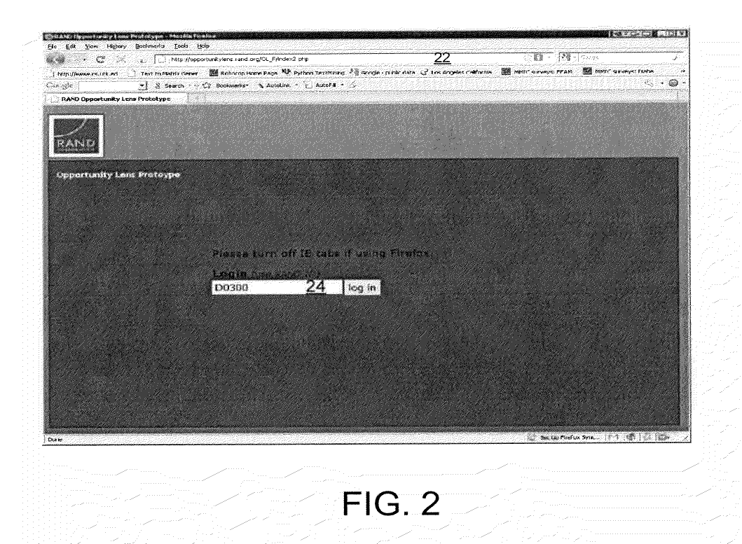

A user (e.g., at a remote terminal) typically begins the experience by opening an internet browser, such as Mozilla Firefox or the like, on a display of the remote terminal device 12. Users may be presented with a login screen (e.g., as shown in FIG. 2). The user will enter a URL for the system interface into the address bar 22. A login screen may appear and the user may enter a unique user id 24.

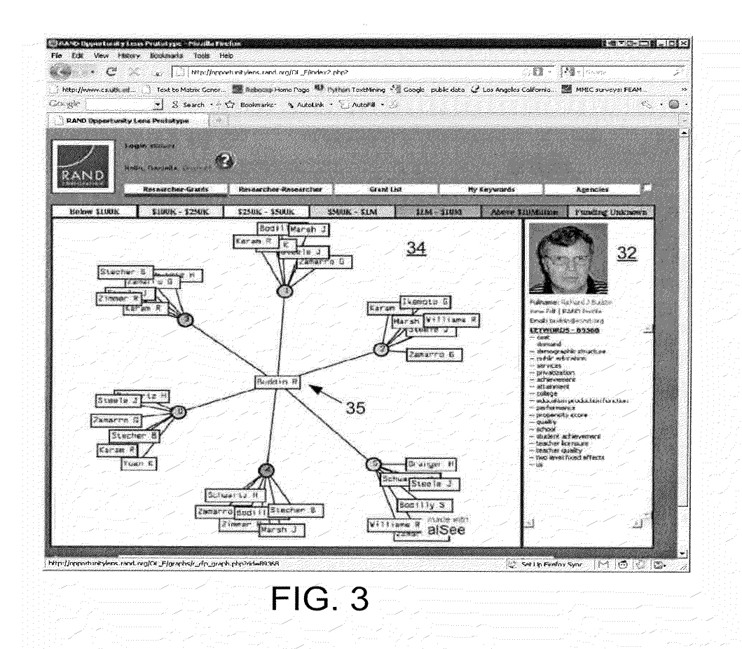

In the main diagram 34 on the Researcher-Grants screen (FIG. 3), the default view presents the logged-in user as the center rectangular node 35. Surrounding the researcher are circular nodes. These represent the funding opportunities with the closest distance value to the center researcher's expertise, based upon that researcher's text profile. The length of the edges in the diagram is inversely proportional to the semantic distance between the researcher and the document represented. Funding opportunity nodes are color-coded to reflect the funding range in the horizontal bar located at the top of the diagram. The outlying rectangular nodes represent researchers with expertise that closely match that of the RFP nodes displayed. A researcher-grant-researcher network view initially shows researchers as the “trunk” of a tree to visualize basic features of top ranked RFPs as branches, with leaves indicating potential collaborators with interests matched to the same RFP. The researcher in this example is a senior economist whose interests include K-12 education, post secondary education and training, and workforce management. Selecting a node re-centers the network graph, redrawing the screen with the clicked node at the center. In the embodiment exemplified in FIG. 3, two interactive network visualizations, each initially focused on the current researcher, are available.

The right pane 32 of the screen contains information that changes as the user highlights the various nodes (e.g., by moving a mouse pointer). When the user highlights a rectangular researcher node, the researcher's profile, which may include, for example, his/her name and photo, appear in the right screen margin, as well as, for example, links to the CV file, staff directory information, the researcher's email address, a link so that the researcher can be contacted about collaboration opportunities, and/or the like. When highlighting a node representing a funding opportunity, information such as (but not limited to) the grant agency, title, funding level, proposal due date, grant description are displayed, and/or the like. A list of keywords describing the expertise of each researcher may also be displayed.

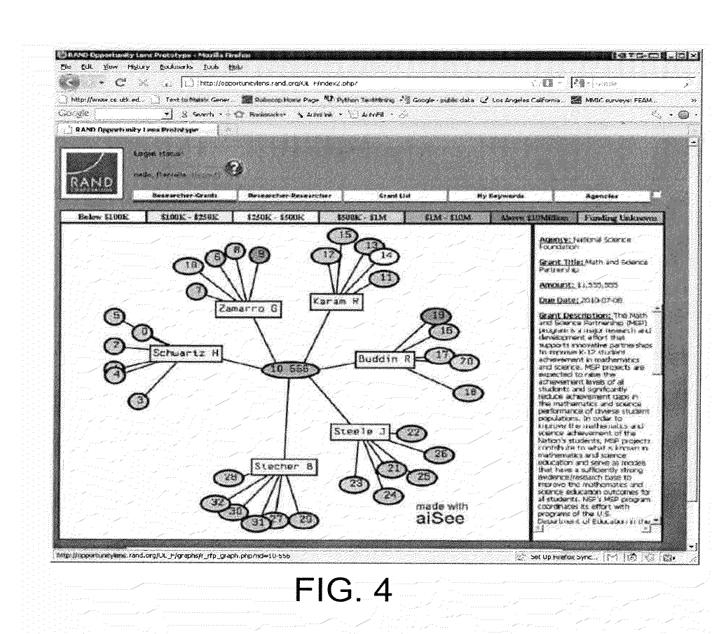

Selecting an oval RFP node creates an RFP-centric researcher diagram, as exemplified in FIG. 4, which may help researchers identify interdisciplinary collaboration opportunities where researchers have complementary expertise that satisfies client needs. The visualizations are interactively generated. Users can select any of the other researcher or grant nodes and re-draw the diagram centered onto another researcher or onto a funding opportunity.

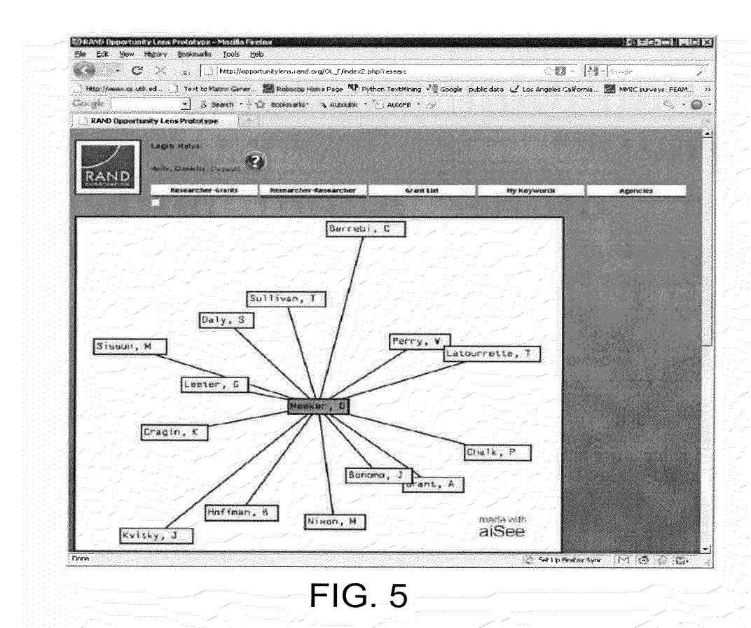

With reference to FIG. 5, various embodiments provide a Researcher-Researcher network view that displays a researcher-centered diagram showing other researchers with closely related expertise and interests. This view may help researchers find others in the organization with similar interests.

This view initially displays the logged-in user positioned in the center node, surrounded by researchers with expertise that most closely match that of the user, based upon matching of their profiles. As with the Researcher-Grant screen, highlighting any of the researcher nodes will display that researcher's information from the “researcher data” table in the database, in the pane to the right. The lengths of the edges connecting nodes in the network diagram are proportional to the distance between researchers so that researchers with the most similar keywords are positioned closest together in the diagram.

The same diagramming program can take a variety of parameters to change the “degrees” and of the diagram indicating other researchers whose interests are similar to those of the researcher in the center rather than RFPs whose content is similar to the researcher's interests. This enables researchers to navigate the organizational network based on how similar researchers' interests are.

The user can then select on any of the outlying researcher nodes. This will cause the diagram to redraw and display the selected researcher in the center, surrounded by researchers with the most closely matched profiles to the researcher in the center. A list of grants ordered by similarity to researcher's interests will be displayed in a Grant List screen (refer to FIG. 6). In addition to meta-data related to grant titles, the agency, funding level, and proposal due date are also displayed.

With reference to FIG. 6, a “keyword search” field 62 also enables researchers to search the “rfp data” table in the database. This will search all RFPs in the database based on the entered terms, rather than the set of terms in the researcher's keyword list. The total number of matching RFPs is given.

In addition to the search field 62, this particular embodiment includes some other interactive features. A “more” button 64 expands the title field to include the summary content of the RFP. Selecting (e.g., clicking) the title text will open a new browser window to the network location of the RFP.

Importantly, prospective applicants can rate results that reflect whether a particular result is of interest to them in the “topically relevant” column 66. These are graphically displayed as an icon shaped like a human thumb. The tip of the thumb extending downward toward the bottom of the screen indicates a negative rating. A thumb pointing to the top of the screen indicates a positive rating. A 50-pixel by 50-pixel box between the two indicates an intermediate, neutral rating. Users can select these icons to enter their rating. These ratings are delivered to the database and used to refine the similarity calculation algorithms as indicated with respect to FIG. 1.

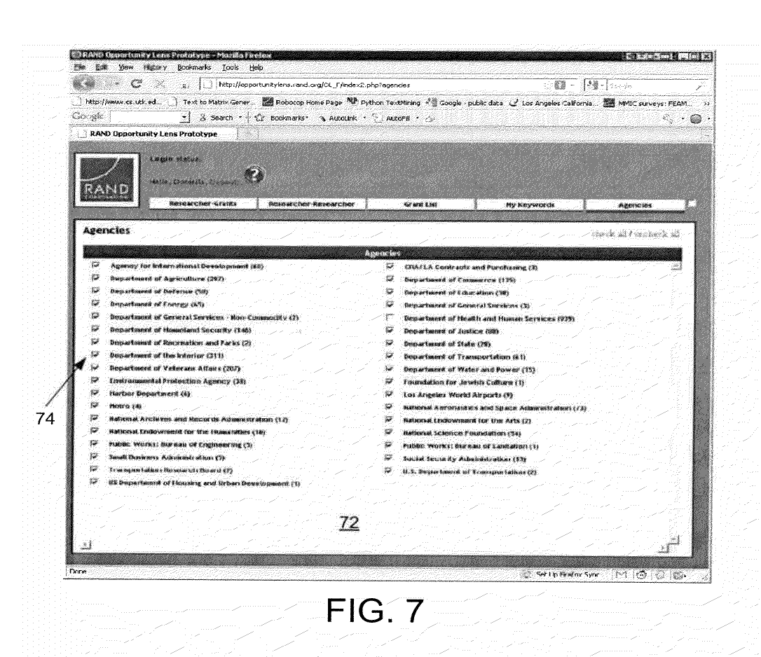

With reference to FIG. 7, in addition to the text data used to calculate similarities, RFPs also contain meta-data that may help in filtering out irrelevant RFPs. Researchers may also use the meta-data regarding funding opportunities, for example the funding level or the source agency. In some embodiments, filtering may be enabled based on the agency that issued the RFP, controlled in an “Agencies” screen 72. Here, prospective applicants can customize the result list by selecting the funding sources with which they would like to be matched. Selections will be reflected on both the Researcher-Grants diagram and on the Grant List. Like the keyword screen, the Agencies screen is a hypertext markup language (HTML) form rendered by an internet browser that has a number of checkbox HTML form objects annotated with text describing funding agencies that have published the RFPs in the database. If a user selects an item it will toggle the state of the checkbox 74 between “checked” and “unchecked.” The system 10 will update filters each time the “Agencies” tab is modified. RFPs from agencies that do not have a checkbox with a check mark will not be included in the result set.

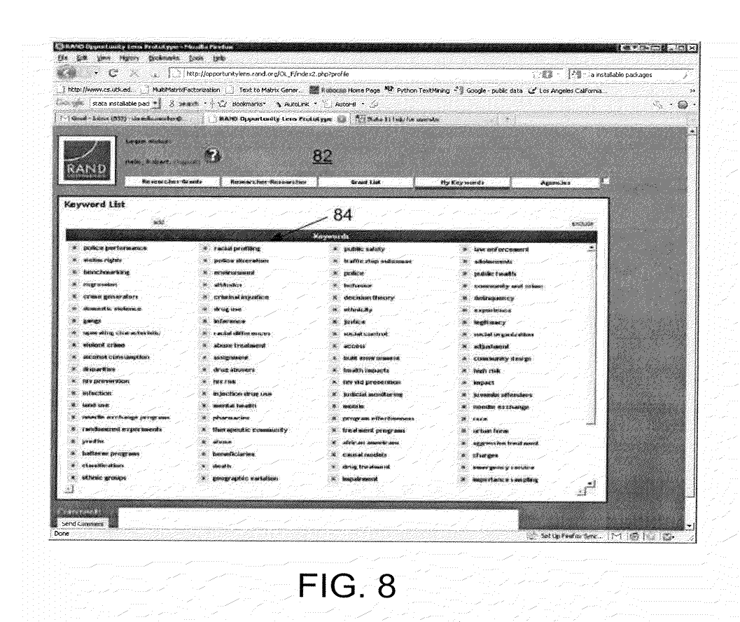

The researcher-keyword table C in the database Y holds the words seen in a profile management screen 82 (e.g., FIG. 8) where users can manage the text that best represents the types of funding opportunities to which they would like to be matched. This is seeded with text data that is extracted from internal organizational databases as well as internet sources, such as researchers' publications in federated databases such as PubMed™. Researchers can modify this content, as well as assign logical filters, which will fine-tune the search for the best funding opportunity matches. Keywords 84 added by the user will be weighted more heavily than those automatically extracted from publications. Researchers can delete and exclude existing keywords. In this embodiment, by selecting the “X” next to the word, a word can be removed from the list of words associated with a researcher. To exclude a keyword, it is entered into the text field next to the “Exclude” button. “Exclude” is used as a filter to eliminate from researchers' personalized RFP results any RFPs that contain the excluded text. When updates are made, the resulting RFP similarity calculations will update. Any changes made to the keyword list will have an immediate effect on the matched RFPs.

With reference to FIGS. 1-8, the programming and markup languages used in various embodiments are described below.

Perl is a common scripted programming language, and suited for a variety of purposes, including management of text files. Hypertext Preprocessor (PHP) is a widely-used Open Source general-purpose scripting language that is especially suited for Web development and can be embedded into HTML, with many common features with perl. Python is also similar to perl. Javascript is a common language that can be rendered by common internet browsers to create client-side programs that are executed by the local machine's internet browser. MATLAB is a matrix-based programming language; information is available at http://www.matlab.com. For graphical rendering software, the system 10 may use aiSee, currently available at (http://www.aisee.com). The system 10 may use an operating system such as Linux (e.g., Linux Red Hat 2.0) or the like. The network protocols and access programs are HTTP—Hypertext transfer protocol and FTP—File transfer protocol or the like. The embodiment described and pictured in FIGS. 2-7 used the Mozilla Firefox web browser. For database platforms, the system 10 uses and accesses MySQL and Oracle databases. In particular embodiments, the database Z is MySQL. The acquisition programs (e.g., 1, 2) used to gather researcher and RFP data and generate the graphical user interface is written in Python, Perl, PHP, JavaScript, and aiSee. Algorithms for calculating distances are implemented in MATLAB.

Interactive data may be based on explicit content; for example researchers' publications data, ratings of RFPs, previous proposals, and/or the like. Implicit data from an interactive interface may also be collected; for example response timing, computer mouse activity, requests for more information, browser-based information about internet navigation history, and/or the like.

Furthermore, the user interface X may include a mixture of results that have been created by different algorithms and/or parameters. The use of the interactive data may be used to tune and select algorithms and parameters either adaptively or by human process intervention.

As implied above, the analytic models used for similarity calculations may have parameters that change based on data collected during interactions. For example, in the use case described below, the calculations are updated dynamically as a user adds more information about preferences—if a particular result is deemed irrelevant, similar results are also “demoted” in real time based on the algorithms used.

An embodiment may use any number of methods from a large universe to calculate similarities and update metrics. Matrix factorization methods may be one of the common examples of methods that reduce and rotate the dimensions for similarity metrics that do not overfit the data. Factorization can be thought of as creating a new model or spatial transformation that can be used to calculate the angle between vectors to measure similarity between points in space, in our case semantic space. Singular value decomposition (SVD) may be applied as discussed below.

Another approach includes a generalized method of factorization called multi-relational matrix factorization (MRMF). Lippert and colleagues describe this algorithm for jointly decomposing matrices of varied dimensionality to exploit correlations between an arbitrary number of data objects represented as matrices, potentially including data representations of characteristics such as linkages between object types and temporal dynamics of data.² These approaches typically allow feedback data, such as ratings information, to be incorporated into the spatial rotations. MRMF is a generalized method. One of the most commonly applied methods that is a special case of MRMF is nonnegative matrix factorization (NMF) (William, 1971; Paatero, 1994, both of which are herein incorporated by reference in their entirety). Related approaches have recently received publicity in relation to the Netflix Prize, a contest for developing algorithms for recommending movies most similar to individuals' interests based on ratings histories.³ This type of recommendation based on similarity across users is often referred to as “collaborative filtering.”²Lippert, C.; Weber, S. H.; Huang, Y.; Tresp, V.; Schubert, M. & Kriegel, H.-P. (2008), Relation-Prediction in Multi-Relational Domains using Matrix-Factorization, in ‘NIPS 2008 Workshop: Structured Input-Structured Output’, which is herein incorporated by reference in its entirety.³Robert Bell, Yehuda Koren, and Chris Volinsky. The bellkor 2008 solution to the netflix prize, December 2008. http://www.netflixprize.com/assets/ProgressPrize2008_BellKor.pdf, which is herein incorporated by reference in its entirety.

In various embodiments, the system 10 embodies the human process described in the background in a tool created to match and improve the ability to identify and rank documents from a corpus based on similarity to personalized participant profiles. The opportunities in one of the embodiments relates to funding opportunities that may be available in different online databases or online web pages. The group of applicants in one of the embodiments may, for example, include university researchers in a particular college, department, etc. Further, the system 10 matches the participants with each other generally and in very specific context and allows them to collaborate in solving a common challenge. The matching of participants occurs based on their commonality of general interests, or based on specific opportunities being pursued where complimentary skills may be needed. After matching the participants, the system 10 facilitates collaboration by allowing participants to exchange relevant information provided by the participants (e.g., resume, webpage, etc.) and initiate communications (e.g., e-mail). The system 10 also allows for matching policy makers to policy relevant literature, ranking of candidates for specific jobs based on resumes, and other information provided in text.

Customized extract, transform, load (ETL) programs are scheduled to run on a nightly basis to collect data from sources where funding opportunities are published. This data are collected either with direct queries of internal databases, RFP databases that can be downloaded with FTP, or by programmatically downloading web pages from RFP sites that are based on templates that have formatted fields corresponding to relevant data elements such as RFP title and RFP funding level (commonly called “web scraping”). The text in RFPs is statistically compared to text in applicants' profiles to calculate similarity between each prospective applicant's profile and the funding opportunity description. Since the texts of documents, which are used for matching, have very large vocabulary, a number of methods are used to project the text in smaller dimensional vocabulary space. This can be accomplished by using singular value decomposition, non-negative matrix factorization, MRMF, artificial neural networks, and/or the like. Profiles are generated based on both user input and source databases. In addition, the recommendations for potential collaborators whose profiles are also available are generated using the same distance calculations. The data sources in the system 10 include multiple organizational databases containing researcher information, researcher keywords, and past publications, as well as the assembled database of funding opportunities translated from network data sources.

According to various embodiments, there are two types of data objects used to calculate similarity. These include (1) the ratings each user has assigned to each RFP and (2) the terms contained in the text documents. Once defined, similarity calculation programs are executed as new data comes in order to populate tables of distances between researchers and funding opportunities and researchers and other researchers.

For the purposes of this description, the expression “document” refers to the text contained in either researchers' list of keywords, their publications and past proposals, and the text of the funding opportunity. The documents are used to create a model of semantic space that will be used to calculate similarity between the documents in that space. The space is a projection of a Term-Document Matrix (TDM), an example of which is shown in Table 2. A raw term document matrix has a column for each document and a row for each term, where term is generally a feature of the document, in particular a word or a phrase contained in the document. Each cell represents a measure of how frequently a term appears in each document. The dimensions of this matrix are m×n, n=n1+n2, where m is the number of totality of unique terms, tokens, or features of RFPs and all researcher profiles, n2 the number of researchers, and n1 the number of funding opportunities. In some embodiments, each term may be down weighted by their commonality and the document length may be normalized.

A*_{1(m×n1)}=Term-document matrix of funding opportunities;
A*_{2(m×n2)}=Term-document matrix of researcher expertise content;
A*_{m×(n1+n2)}=Combined term-document matrix.

TABLE 2
Term-Document Matrix A*, m = 19, n₁ = 2, n₂ = 3

| | | | A*₂ | | | |
|---|---|---|---|---|---|---|
| | A*₁ | | | | FRE- | |
| | RFP | RFP | RIDGEWAY, | GLENN, | MONT, | BELL, |
| | # 16 | # 17 | G | E | A | D |
| Policing | 1 | 0 | 7 | 0 | 2 | 0 |
| Justice | 5 | 0 | 14 | 0 | 0 | 0 |
| Domestic | 0 | 0 | 10 | 2 | 4 | 0 |
| Vulnera- | 0 | 0 | 0 | 0 | 10 | 0 |
| ble | | | | | | |
| Emergen- | 3 | 4 | 5 | 6 | 15 | 3 |
| cy | | | | | | |
| Care | 0 | 0 | 0 | 27 | 13 | 12 |
| GIS | 0 | 0 | 3 | 0 | 24 | 0 |
| HIV | 0 | 7 | 0 | 20 | 0 | 5 |
| AIDS | 0 | 6 | 0 | 9 | 0 | 14 |

The system 10 pre-processes documents before constructing the TDM for removing common words and words which have common linguistic roots, and adding phrases to improve the performance of our methods. Such methods are described below.

The system 10 may implement a stoplist to exclude a list of common words like “is,” “have,” “it,” etc. from the analysis. A customized list may be used for this purpose.

The system 10 may also maintain a customized list of terms that are used as filters to eliminate documents from the TDM and result set. These terms may include “SBIR,” “Fellowship,” “Mentorship,” and/or the like.

In various embodiments, the system maintains a table of tokenized phrases in the table_app_tokenized_words. Multi-word phrases that appear as keywords for more than three researchers are added to a library of tokens. If a tokenized phrase appears in a document, the count for each word is incremented as well as the token. Some examples of tokenized terms in the database include: Alcohol marketing; Life expectancy; Multiple imputation; Bosnian refugees; Urban youth; Mental disorder; Updated recommendations; Los Angeles County; Medicare managed care; and Chronic care. In practice, tokens do not have to represent text content. A token can represent any type of meta-data or feature associated with a weighted value in content of interest; for example, features could include tokens for funding agencies. Weights for funding agency tokens assigned to researchers would be proportional to past funding from that source; weights assigned to funding agency tokens in RFPs according to the RFP's funding source(s). Other examples include tokens that represent co-authorship or citation ties between researchers. The purpose of weights is to indicate how strongly a particular token is associated with a researcher.

In various embodiments, the system 10 applies a Porter stemming algorithm (van Rijsbergen, 1980⁴) to retain parity between the conceptual meaning of words like “screening” and “screen.”⁴C. J. van Rijsbergen, S. E. Robertson and M. F. Porter, 1980. New models in probabilistic information retrieval. London: British Library. (British Library Research and Development Report, no. 5587), which is herein incorporated by reference in its entirety.

Historically, several methods have been applied for weighting the cells in the TDM in order to adjust for how frequently terms appear within a document or globally over the entire collection of documents. For any given method created for similarity calculation, the domain expert would select the best weighting approach for his purposes and the characteristics of data sources. Salton and Buckley give a thorough treatment of this topic in Salton5, which is herein incorporated by reference in its entirety. ⁵Salton, Gerard and Buckley, C. (1988). “Term-weighting approaches in automatic text retrieval”. Information Processing & Management 24 (5): 513-523, which is herein incorporated by reference in its entirety.

The system 10 may implement MATLAB TMG package (Berry, 1999⁶; Kolda, 1997⁷) which offers many programs for semantic analysis, clustering, and classification. Table B is a snippet of current code used to invoke TMG to create a term document matrix with the desired parameters and weight the entries as appropriate. ⁶M. Berry and M. Browne, Understanding Search Engines, Mathematical Modeling and Text Retrieval, Philadelphia, Pa.: Society for Industrial and Applied Mathematics, 1999, which is herein incorporated by reference in its entirety.⁷T. Kolda, Limited-Memory Matrix Methods with Applications, Tech. Report CS-TR-3806, 1997, which is herein incorporated by reference in its entirety.

TABLE B
Matlab code for creating TDM

%apply Porter Stemming
OPTIONS.stemming=1;
%use the custom stoplist
OPTIONS.stoplist=‘/vincent/a/dmeeker/SA/locstoplist.txt’;
OPTIONS.global_weight=‘f’;
OPTIONS.local_weight=‘l’;
%use only terms that occur at least twice
OPTIONS.min_global_freq=2;
% file where today's TDM is saved (keep track of parameters in title)
fname=strcat(‘path/to/documents/,‘TMG_desc’,
OPTIONS.global_weight,OPTIONS.local_weight,‘_’,
date,‘.mat’)
% calculation of TDM
[A,D,GW,NORM,WORDCOUNT,TITLES,FILES]=
TMG(files,OPTIONS)

Because the number of terms can be large (10,000+) and the number of documents (e.g., RFPs) can be large, the data for assigning RFPs to researchers are very noisy and thus potentially prone to error. To deal with this, the system 10 implements a technique invented at Bellcore (see Deerwester, Dumais, Furnas, Landauer & Harshman, 1990⁸) called “latent semantic indexing” (LSI). To extract the underlying semantic information from these documents, the system 10 needs to avoid basing researcher-RFP connections on the idiosyncrasies of individual documents and maintain only the most important underlying structure of the original TDM. LSI applies a singular value decomposition (SVD) to the TDM, A*, and selects the p most influential singular vectors to give a lower rank approximation to the original term document matrix. More specifically, SVD will approximate A* by the corresponding p-dimensional singular value decomposition into the product of three matrices,

A_{m×n}=T_{m×p}×S_{p×p}×(V_{n×p})^{T},

where m=number of terms, n=number of documents (n1 RFPs, and n2 Researchers), and p is the number of singular values used for decomposition; p<=rank of (A*)<=min(m,n). Here T has orthogonal column vectors referred to as the left singular vectors, and similarly V consists of orthogonal unit vectors known as the right singular vectors. S is a diagonal matrix of positive singular values in decreasing order. ⁸S. Deerwester, S. T. Dumais, G. W. Furnas et al., “INDEXING BY LATENT SEMANTIC ANALYSIS,” Journal of the American Society for Information Science, vol. 41, no. 6, pp. 391-407, September, 1990, which is herein incorporated by reference in its entirety.

The choice of p is somewhat based on empirical results, the size of p depends on how close approximation is desired and how different in magnitude the singular values are to each other. If p is chosen to be equal to the rank of (A*), the result is an “approximation” (corresponding to key-word searching). The rows of T matrix represent terms, and rows of V matrix represent the documents (n1 RFPs and n2 Researchers) in the same p-dimensional space.

Thus any document d (a column of A* representing a researcher or RFP) can be approximated by \hat{d}—a p dimensional vector of the terms weighted by S

\hat{d}ₚ=d_{1×m}T_{m×p}×S_{p×p}⁻¹

Projecting a new document that was not part of the original corpus is referred to as “folding-in.” By reducing the dimensionality of the space to p our aim is to eliminate noise from A* that is not informative about how different documents are related to one another, and to create a space composed of “concepts” or “factors” of weighted terms from our texts. A rough “rule of thumb” is to set p to be 500 for medium-sized documents. That choice strikes a balance between the noisiness and efficacy.

The rows of V are document vector coordinates, so to compare any two documents cosine similarities can be computed to identify a similarity measure. The rows of T are term vector coordinates, so to compare any two terms the cosine similarities can be computed to identify a similarity measure.

The general case, an arbitrary query string q, can be represented as a frequency count of each of the terms in T present in that query and projected into this “p space” defined by S and T:

\hat{q}₍ₚ₎=q_{1×m}T_{m×p}×S_{p×p}⁻¹

At this point the query is analogous to any row of D, and can be compared directly with a similarity measure. In this embodiment, users are also able to construct such queries in a search box in order to search for documents of interest.

If two documents (such as an RFP and a researcher's keywords) are similar, then the pattern of their term frequency vector will be similar. By taking the inner product of their term frequency vectors, a larger value is obtained than if they were dissimilar. The similarity is this inner product between two documents and is calculated as

sim(d₁,d₂)=\hat{d}_{1,p}Sₚ²\hat{d}_{2,p}

This is used for ranking the RFPs \hat{d}_{1,p}'s for a given researcher (represented by \hat{d}_{2,p}) in absence of feedback (e.g., 3 in FIG. 1). The definition of similarity used here will be the same as cosine similarity if documents are normalized by the length of documents in the TDM A*. In general, terms can be projected into document space or documents into term space and identify similarities accordingly.

In the program MATLAB code for singular value decomposition and the reconstruction of construction of a lower rank approximation to the original matrix is shown in Table C, which has Singular value decomposition (400 dimensions).

TABLE C
Matlab Singular Value Decomposition.

%Singular Value decomposition
[T,S,V]=svds(Astar,400);
% A is the TDM reconstructed from the SVD
A=U*S*V’;

As described above, the cosine similarity is based on the normalized dot-product of the vectors of the TDM or reduced rank TDM. TMG provides the function VSM, short for “vector space model,” which can be used to calculate the normalized dot product. This calculation is conducted for every researcher and document. Using the TMG package in MATLAB, the calculation is implemented as shown in Table D.

TABLE D
Distance Calculation by Vector Multiplication.

%calculate vector space distances
%arg 1 - res_query is the projection of the researcher's keyword
list onto the TDM
%arg 2 - is the flag for normalized calculation (set here to 1)
%SC is the vector of ordered similarity calculations
%DOC_INDS are the indices of the ordered documents in the
FILES array produced by TMG( ).
[SC, DOCS_INDS] = vsm(A,res_query,1);
%using the projection on Astar, the p-dimensional SVD-based TDM.
res_query_star=Astar(:,ri);
[SC_star,DOCS_INDS_star]=vsm(Astar,res_query_star,1);

The aim of the funding opportunity-researcher matching use-case is to predict the funding opportunities of highest interest to researchers based on content. The system 10 at the initial stage, without any feedback from any of the users, uses the similarities between the researcher terms projected into p-space and document terms projected into p-space. However, feedback from users (in the form users' personal RFP ratings and/or application history) may be used to customize the projection of researcher terms so that the similarity measure between the customized projection and highly rated RFPs is minimized. Here two key example models for including the calibration of this data are described. For this, the following notation is needed.

Let A*=[A*₁,A*₂]_{m×(n1+n2)},A*₁=RFPs,A*₂=Researchers,n=n₁+n₂.

As above, A* is approximated by

A=[A₁A₂]=TSV^{t},T_{m×p},S_{p×p}=diag(s₁, . . . ,sₚ),

T′=[t₁′, . . . ,tₘ′],T=[u₁, . . . ,uₚ],V=V_{(n1+n2)×p}=[v₁, . . . ,Vₚ].

−>A=Σ_{k=1,p}(sₖuₖvₖ′)

Now, decompose V′, the transpose of V matrix,

V′=[F,R];F=[f₁, . . . ,fₙ₁],R=[r₁, . . . ,rₙ₂],

F, R and T′ represent the documents corresponding to n₁ RFPs, n₂ researchers, and m terms respectively in the same p dimensional concept space.

T′T=I,V′V=F′F+R′R=[vᵢ′vⱼ]=I, by orthogonality of u's and v's.

The similarity relationship between RFP and researchers is given by:

A₁′A₂=FST′TSR=FSSR==[c_{i,j}]=[wtd inner product of i^{th} RFP and j^{th} Researcher weighted by the singular values]. Similarly, the researcher to researcher-relationship is given by A₂′A₂.

Thus similarity between i^{th} rfp and j^{th} researcher,

c_{i,j}=Σ_{k=1,p}sₖ²ƒ_{i,k}r_{j,k},i=1, . . . ,n₁,j=1, . . . ,n₂ (1)

Initially, the similarity between researcher and RFP is based on c_{i,j}. As researchers reveal their preferences, feedback is used to modify c_{i,j} and r_{j,k} to c^{new}_{i,j} and r^{new}_{j,k}, respectively. For these purposes, the following two methods are used, one based on a statistical learning model, and the other based on the nearest neighbor smoothing method. Descriptions of each are provided below. For this, more notations are needed. Let y_{i,j}=1 if the j^{th} researcher rated the i^{th} RFA favorably; yᵢⱼ=0 if he/she rated it unfavorably. Let Mⱼ=set of RFPs for which preference is known for the researcher. Now we learn in this content-based model while keeping all RFP's, words and researchers in the same p space in the following two ways.

Method 1. A number of statistical models are considered. We assume that y_{i,j} are Bernoulli (1,γ_{i,j}), where γ_{i,j}=Prob{y_{i,j}=1}=1−Prob{y_{i,j}=0}. Then the model is logit(γ_{i,j})=c^{new}_{i,j}i.e., γ_{i,j}=exp (c^{new}_{i,j})/(1+exp (c^{new}_{i,j})). Then,

Log Likelihood (y_{i,j}|c^{new}_{i,j})=Σ_{i,j}{y_{i,j} log (γ_{i,j})+(1−y_{i,j}) log (1−γ_{i,j}))} (2)

This would allow us to do a number of diagnostics in terms of how good the model fits, etc.

The model is now completely specified once the c^{new} _{i,j} is prescribed. Initially, without any feedback, we initialize with c^{new}_{i,j}=c_{i,j}=Σ_{k=1,p}sₖ²f_{i,k}r_{j,k} as above and our ranking of RFPs for a given researcher and researcher-to-researcher ranking are based on it as before.

After observing y_{i,j}, c^{new} _{i,j}=α+βΣ_{k=1,p}sₖ²f_{i,k}r_{j,k}(1+θ_{j,k}), where α, β and θ_{j,k} are parameters which need to be estimated.

The model has institutive behavior that j^{th} researcher is moving by an additive factor θ_{j,k} r_{j,k} to the k^{th} component r_{j,k} towards the positively rated RFPs and away from negatively rated RFPs.

Thus, c^{new}_{i,j}=z_{i,j}+βΣ_{k=1,p}sₖ²ƒ_{i,k}r_{j,k}θ_{j,k} (3)

where z_{i,j}=α+βc_{i,j}, (4)

That is, each researcher has free parameters θ_{j,k}, k=1, . . . ,p. In effect, there are new 2+n₂ p parameters that can be estimated by the Maximum Likelihood method using the likelihood given in (2). The performance of this approach will not be satisfactory, since the number of parameters, 2+n₂ p is large. To reduce this, we penalize the likelihood when θ_{j,k} are non-zero. Towards this end, we use

Regularized Log Likelihood=Σ_{i,j}{y_{i,j} log (γ_{i,j}(θ))+(1−y_{i,j}) log (1−γ_{i,j}(θ)))}−λΣ_{j,k}ƒ(θ_{j,k}), where log (γ_{i,j}(θ)/(1−γ_{i,j}(θ))=z_{i,j}+βΣ_{k=1,p} sₖ²ƒ_{i,k}r_{j,k}θ_{j,k}, where z_{i,j} is given in (5)

Here, ƒ is a convex function—ƒ(x)=x̂2 would be similar to ridge regression, while ƒ(x)=abs(x) would give rise to a Lasso type of procedure. We use ƒ(x)=abs(x) with λ determined by cross-validation.

For estimating this model, we use LARs algorithm as implemented in glmnet package in R (Friedman, 2010⁹). As the result of this model, after the feedback, one obtains new p-dimensional representation of each researcher. ⁹Jerome Friedman, Trevor Hastie, Robert Tibshirani (2010). Regularization Paths for Generalized Linear Models via Coordinate Descent. Journal of Statistical Software, 33(1), 1-22, which is herein incorporated by reference in its entirety.

rⱼ^{(new)}=[r_{j,k}^{(new)}], where, r_{j,k}^{(new)}=r_{j,k}(1+θ_{j,k}) (6)

Method 2 (Nearest Neighbor Method). This method is a simpler version of Method 1t, but does not fit a formal statistical model and consequently has fewer parameters. After observing y_{i,j} for i in Mⱼ with cardinality mⱼ, we modify r_{j,k} to r_{j,k}^{(new)} by,

r_{j,k}^{(new)}=r_{j,k}θⱼ+((1−θⱼ))/mⱼ)Σ_{i in Mj}f_{i,k}(2y_{i,j}−1),j=1, . . . ,n₂. Again, rⱼ^{(new)}=[r_{j,k}^{(new)}] (7)

Thus, instead of 2+pn₂ parameters, we only have n₂ parameters. For the researchers who have no feedback, θⱼ=1. We determine θⱼ by cross-validation on the observed feedback. If the feedback data is very scant, then we reduce the number of parameters to 1, by assuming—θⱼ=θ.

In experiments with Method 2, with the scant data, a common θ is assigned for all researchers, which is determined by cross validation on previously collected rating data. Iterating over each of the researcher's ratings with a positively rated test case “held out” in each repetition, similarity is calculated for rated RFPs and using various values of θ to generate a rank-ordered list. The value for θ is selected that generates similarity measures giving the lowest average rank (greatest similarity) to the positively rated test cases.

As stated above, the same system may use different distance calculation algorithms in different contexts. In the case of these two example methods, the first method can be used when time and/or CPUs are available for calculation and model estimation. The second method calculates more quickly and thus can be applied in settings when speed in updating results is an important requirement.

Both of the above methods give us new p-dimensional representation rⱼ^{(new)}=[r_{j,k}^{(new)}] of each researcher by the equation (6) and (7).

Given rⱼ^{(new)}, we can compute after the feedback, R^{(new)}=[r₁^{(new)}, . . . ,rₙ₂^{(new)}] and, A ₂^{(new)}=USR^{(new)}. Recall, A₁=USF, F=[ƒ₁, . . . ƒₙ₁].

Finally, A^{(new)}=[A₁, A₂^{(new)}] is the new estimated TDM.
1. New researcher-to-researcher score is ranked by=A₂^{(new)}′A₂^{(new)}, which is equal to R^{new})′*S*S*R^{(new)}), the score for ith RFP and jth researcher is given by (i,j)th element of this matrix. The second expression is more efficient for computation purposes since the number of dimensions are p instead of m.
2. Similarly, new researcher-to-RFP score=A₁′A₂^{(new))}=(F′)*s*s*R^{(new)}
   For updating the results when there are new RFPs and researchers, we delineate two cases:
3. Case 1: Only few new RFP's and researchers are added: Fold in the term vector (e.g., according to [0076]) corresponding to the new RFPs or researcher profiles and augment them to F and R^{(new)} matrix, and recompute the score as in 1 and 2 above. For deletion, just remove the corresponding columns in F and R^{(new)} matrices.
4. Case 2: If most RFPs are new, complete updating of A₁* matrix is required, and in that case start with A*=[A₁*,A₂^{(new)}], and repeat steps above (e.g., from [0082] to [0087]) and then follow either of the methods.
5. Additional Feedback: Once we have more feedback, then update the new feedback rating matrix and apply steps 1 through 2 above.

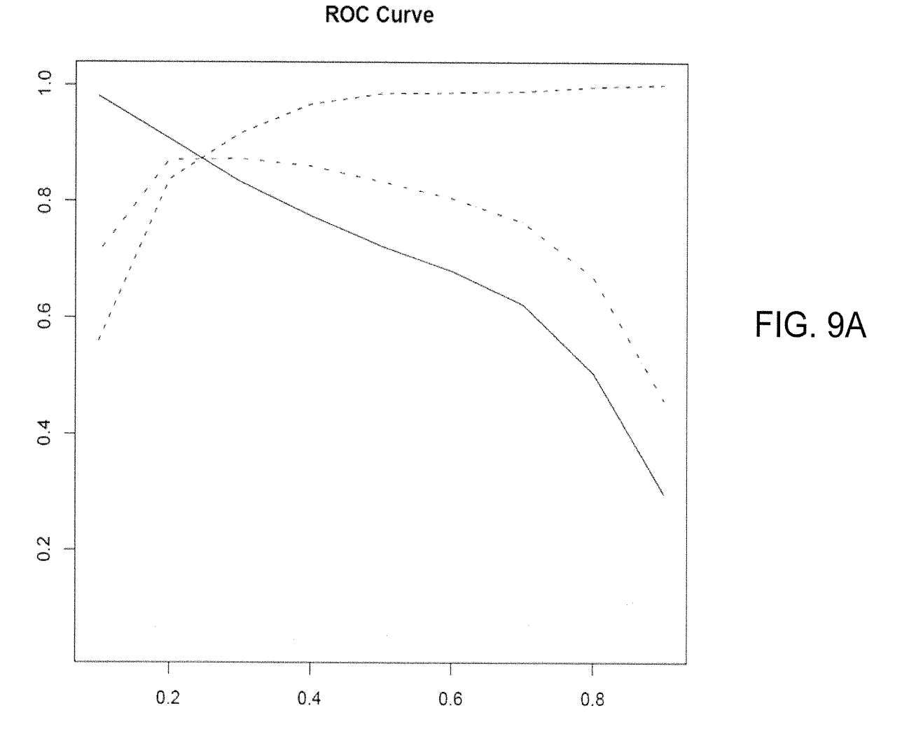

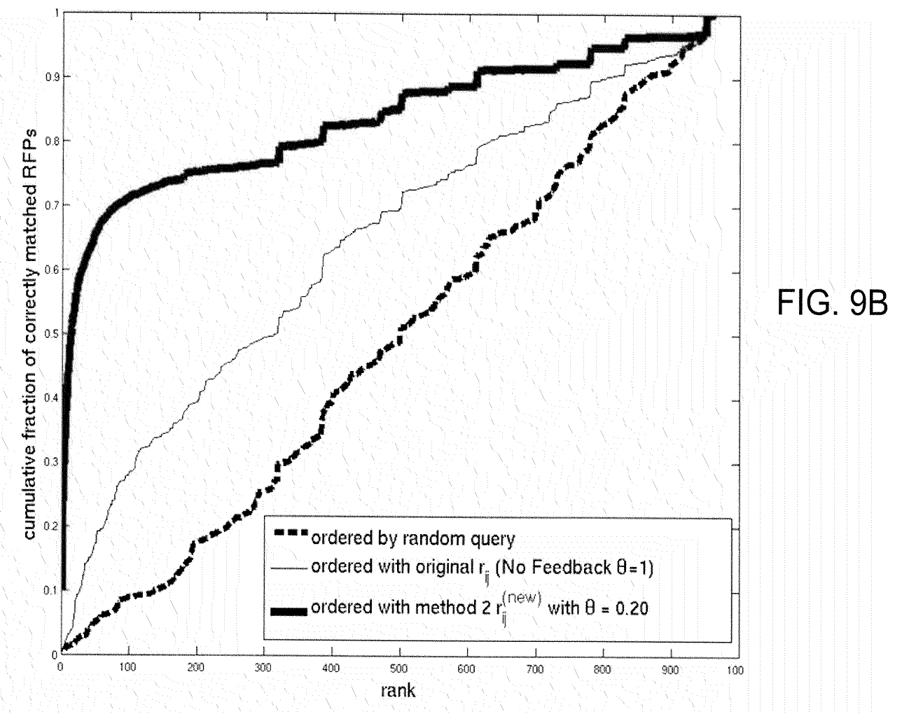

Experiments: In the pilot deployment, 52 researchers rated over 900 unique RFPs that were presented to them in the user interface X described above. Using these data we also conducted offline calculations, using these two different methods for calculating similarity between researchers and RFPs. Two important characteristics of information retrieval performance are precision—the fraction of retrieved RFPs that are relevant and recall—the fraction of relevant RFPs that are retrieved for a given list length or distance measure threshold. FIG. 9A gives the receiving operating characteristic curve (ROC) for RFPs retrieved using Method 1, giving precision and recall of predicted ratings for the rated RFPs at various thresholds for probability that an RFP is rated favorably vs. unfavorably. Precision and recall rates are substantially higher than what is traditionally been reported in information retrieval literature. If, instead of attempting to predict ratings, we order RFPs by similarity in a ranked list, of results, we can measure the cumulative fraction of favorably rated RFPs as rank increases. When this cumulative area is plotted against rank, a large area under the curve implies better the performance, since the favorably rated RFPs appear higher in the ranked list. FIG. 9B is a plot of this measure averaged over all researchers for Method 2, ratings based on similarity calculated on LSI without feedback, and a random projection.

FIG. 9A (Method 1) shows the recall (solid line), error rate (dotted line), precision (dashed line), and F-score—the harmonic mean of the precision and recall (dotted-and-dashed line). In this case, thresholding results at roughly 0.3 provides a low error rate and a balance between sensitivity and specificity; each user might prefer a different threshold. FIG. 9B (Method 2) shows a different measure cumulative fraction of favorably rated RFPs when ordered by the distance. A larger area under the curve indicates better recall. The three lines represent three methods calculating the distances used of order the RFPs. First, Method 2, with θ set to 0.2 for all users (thick line), second for Method 2 with θ set to 1 for all users (thin line), and third a random query for comparison (dashed line).

These two methods serve as examples, and do not cover the full range of algorithms or models for optimizing recommendations given rated matches between content and users.

The benefits of the system 10 are targeted at the researcher. However, to the extent that the system 10 matches researchers with appropriate research projects, it also benefits research institutions, the organizations that issue RFPs, and, potentially, the quality of the research.

The system 10 was developed with the intention of adaptation to any application where objects with common features are to be matched and presented or visualized. Thus, many uses beyond researcher-RFP matching can be implemented using the same system. For example, RFPs might be substituted with journal articles or congressional bills and researcher expertise might be substituted with legal dockets in order to identify how research and laws affect court decisions. Various embodiments could involve real time alerts sent out by organizational units as twitter feeds of “tweet-able” moments in congressional sessions relevant to recipients' interests, or automatic updates of which research is featured on an organization's website in response to current events. Under the current software architecture, these substitutions only require adapting the data sources and outputs and, optionally, adding source-specific features as desired.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. Such hardware, software, firmware, or any combination thereof may part of or implemented with any one or combination of the server 14 (refer to FIG. 1), the terminal device 12 (refer to FIG. 1), components thereof, and/or the like. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

### APPENDIX

Listed below are the programs and web sites from which the system obtains active RFPs. They are interoperable with source data as of Jun. 26, 2010.

bidsync_parse.py—iterates over HTML of RFPs published in the website http://www.bidsync.com. BidSync, a comprehensive system that public agencies use to organize, automate, and manage their entire eProcurement processes. By using the BidSync system to process and receive bids, the agency will recognize an immediate increase in productivity and efficiency. Thanks to BidSync, agencies nationwide are saving upwards of 90 percent of the time that they spend on the bidding process and recognizing monetary savings of up to 70 percent. BidSync's bidding system dramatically reduces bid management time and administrative requirements, and improves efficiency for all who participate in the bidding processes.

fbo_parse.py—iterates over HTML of RFPs published on the website http://fbo.gov. This script accesses the page at https://www.fbo.gov and extracts all the links to RFPs in the “bidding” phase. Effective Jun. 25, 2001, the Federal government implemented Section 508 of the Rehabilitation Act of 1973, Amendments of 1998 (29 U.S.C. S 794(d)). Section 508 requires that the federal government only acquire electronic and information technology goods and services that provide for access by persons with disabilities. For more information, see www.section508.gov. Under “Buy Accessible,” a partnership between government and industry, the Information Technology Industry Council (ITI) is hosting a Voluntary Product Accessibility Template on their site. It allows vendors who choose to participate the ability to copy the template and complete it to describe how a particular product or service they offer conforms to Section 508 Access Board standards. This template should be placed on the vendor's accessible web site and the link to the template provided to the Buy Accessible database. Government procurement staff will be able to search the site by specific product or service type and see all vendors who have provided links. They can then use the links to reach the template information and product or service descriptions necessary to complete their market research.

grants_parse.py—The grants.gov website publishes and XML dump of all their RFPs at http://www07.grants.gov/search/XMLExtract do which this script accesses to download the zip file and extract the xml file which then is parsed in order to add/update the RFPs in our database. Grants.gov simplifies the grants management process and creates a centralized, online process to find and apply for over 900 grant programs from the 26 federal grant-making agencies. Grants.gov streamlines the process of awarding over $360 billion annually to state and local governments, academia, not-for-profits and other organizations. This program is one of the 24 federal cross-agency E-Government initiatives focused on improving access to services via the Internet. The vision for Grants.gov is to be a simple, unified source to electronically find, apply, and manage grant opportunities.

labavn_parse.py—This script access the page at http://www.labavn.org/index.cfm?fuseaction=contract.contract_list and extracts all the links to RFPs. The LABAVN site usually does not offer an estimated funding amount, but they may have additional documents that contain more information in their webpage. The Business Assistance Virtual Network (BAVN) is a free service provided by the City of Los Angeles Office of Small Business Services and Minority Business Opportunity Committee. BAVN allows you to view and download information about all bid opportunities offered by the City of Los Angeles in one convenient location as well as find up-to-date certified sub-contractors to complement your project bid.

metro_parse.py—This script accesses the page at http://www.metro.net/EBB/bids1.asp and extracts all the links to listings that have an “RFP” type. The RFPs on the Metro don't offer an estimated funding amount. Metro.net is the website for the Los Angeles County public transportation system. Some of Metro's procurements are for complex, specialized transportation equipment, but like any large company we also need office supplies, consulting services, paint, uniforms—practically anything you can think of We buy from small vendors and multinational corporations.

pnd_parse.py—This program extracts the links at http://foundationcenter.org/pnd/rfp/. These RFPs are sent in to Philanthropy News Digest, which posts them, along with a link for more info. The award amounts are not given.

rfpdb_parse.py—This script accesses the page at http://www.rfpdb.com/ and extracts all the links to RFPs. Since this site requires registration, this script does not extract much data. If all the RFPs on the page are new, then the next page of RFPs is parsed after a 60-second delay. Since all the data on the individual RFP pages are available from the list view, the separate pages are not accessed as in other scripts, but the data is extracted from the list of RFPs.

scag_parse.py—This script access the page at http://www.planetbids.com/SCAG/QuickSearch.cfm and extracts all the links to RFPs in the “bidding” phase. The RFPs on SCAG do not offer an estimated funding amount, but they may have additional documents that contain more information in their webpage.

trb_parse.py—This parser extracts the links at http://144.171.11.40/cmsfeed/trbnet.asp?s=3&r=5. The RFP pages have a table of information at the top, which some of the data is extracted from. A body of text follows, which varies in HTML formatting, so instead textual markers are used to extract the description. There are additional notes on the web pages that are not specific to any one RFP.

What is claimed is:

1. A method of implementing a request for proposals (RFP) management system on a server, comprising:
acquiring RFP data from an RFP data source stored on a first remote electronic device;
acquiring researcher data from a researcher data source stored on a second remote electronic device;
acquiring user preferences from a user interface;
calculating a score based on the RFP data, the researcher data, and the user preferences; and
outputting the score.

2. A request for proposals (RFP) management system, comprising:
a server configured to acquired RFP data from an RFP data source stored on a first remote electronic device;
the server configured to acquire researcher data from a researcher data source stored on a second remote electronic device;
the server configured to acquire user preferences from a user interface;
the server configured to calculate a score based on the RFP data, the researcher data, and the user preferences; and
the server configured to output the score.
